(19) United States
(12) Patent Application Publication
(10) Pub. No.: US 2009/0304984 A1
(43) Pub. Date: Dec. 10, 2009

(54) Material cloth structure used in the punching modeled objects

(76) Inventor: Chia-Liang Chen, Hsinchu (TW)

Correspondence Address: LEONG C LEI, PMB # 1008, 1867 YGNACIO VALLEY ROAD, WALNUT CREEK, CA, 94598, US

(21) Appl. No.: 12/155,683

(22) Filed: Jun. 9, 2008

(51) Int. Cl. B32B 33/00

(52) U.S. Cl. 428/96; 428/221

(57) ABSTRACT

The present invention is to provide a kind of material cloth structure used in a punching modeled object. The said material cloth structure is composed of a cloth layer and a glued film layer, wherein the cloth layer can use ordinary cloth material or other cloth material (such as lint, pile etc.). And, the glued film layer is an airproofed glue film. The glued film is pasted to the backside of the cloth material and an integrated material cloth is thus formed. All forms of three-dimensional punching objects made of this material cloth are hereby provided.

### BACKGROUND OF THE INVENTION

The so-called punching modeled objects in this specification indicate the punching toys often seen in the market that can be inflated and also deflated. This kind of punching modeled object is mostly made of airproofed soft plastics or rubber materials. And, as for the nature of the modeled toys, this changeless plastic sense of quality could not satisfy the needs of people who were fond of sports or games. If the other kinds of more living styled materials could be utilized, for example made of ordinary cloth materials, lint or pile, same as in a soft toy which is able to be inflated or deflated, the punching modeled objects could thus become more versatile and were preferred by the mass consumers, and relatively their sales volumes would be greatly increased.

However, currently in the market, there are no punching modeled objects made of this kind of material seen. Perhaps, someone has tried to produce by enveloping a clothed material modeled object with the same shape on the outside of the plastic punching modeled object directly. But, there are difficulties. If in the punching modeled objects 10 as shown in FIG. 1, it may be possible. But if in the irregular shaped elephant punching modeled objects 10A, it will be hard to be achieved. And even if it can be achieved, just imaging that, there needs to make a plastic punching modeled object and make a clothed material modeled object with the same shape at the same time, then sleeve-assemble these two together. Thus, the manufacturing cost will be greatly increased. Therefore, it is not an ideal method.

### SUMMARY OF THE INVENTION

The present invention is a kind of material cloth structure used in a punching modeled object. It is mainly an improvement for the material cloth structure used in the punching modeled toys. The characteristics and effects of the present invention will be described hereafter by referring to drawings.

### BRIEF DESCRIPTION OF THE DRAWINGS

FIGS. 1, 2 are diagrams of punching modeled objects.

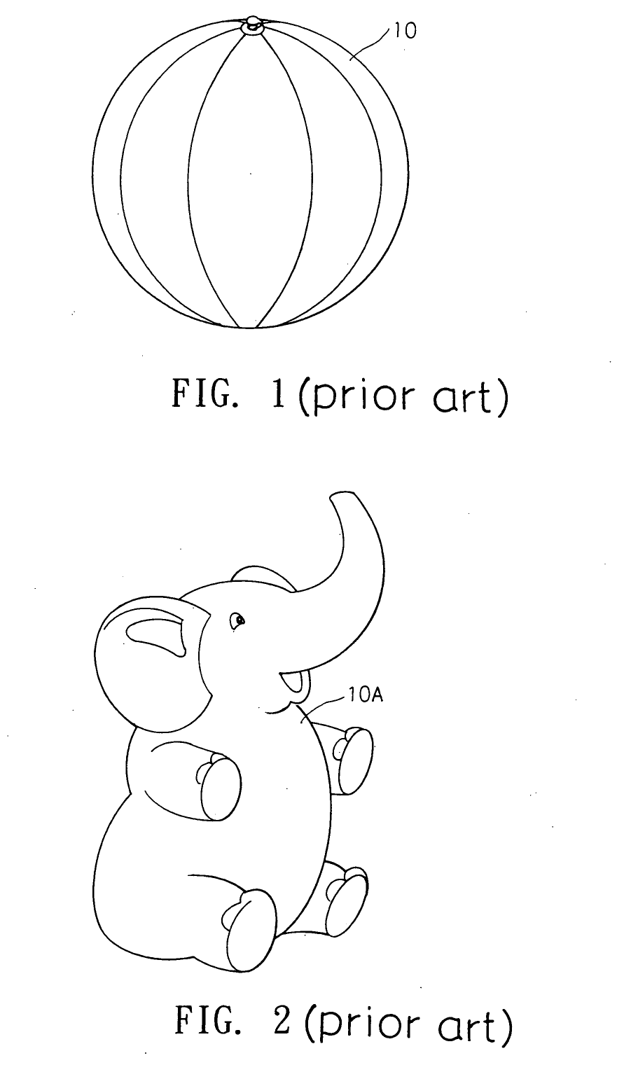

FIGS. 3, 4 are diagrams of the material cloth's configurations in the present invention.

FIG. 5 is an implement diagram of the material cloth jointing in the present invention.

FIGS. 6, 7 are other implement diagrams of the material cloth jointing in the present invention.

### DETAILED DESCRIPTION OF THE PREFERRED EMBODIMENT

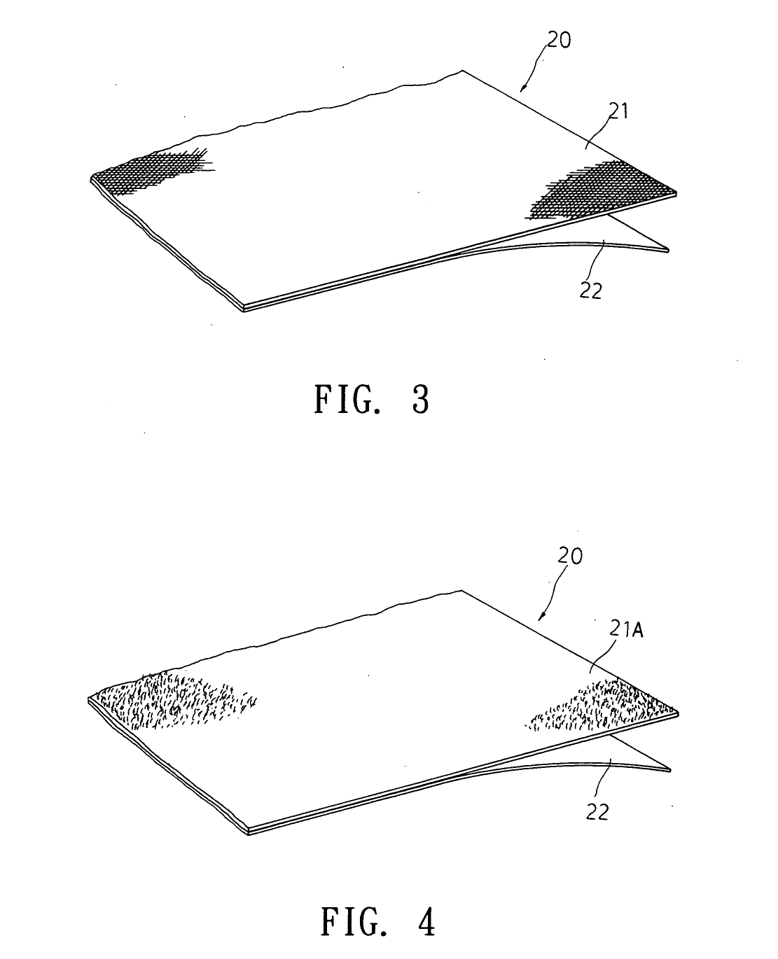

The present invention is related to a kind of material cloth structure used in a punching modeled object. It is mainly aimed to improve the material configuring structure used in the production of the punching modeled toy object. As shown in FIG. 3, the said material cloth 20 is composed of a cloth layer 21 and a glued film layer 22, wherein the cloth layer 21 can use ordinary plain cloth material or lint cloth material etc., or the vertical piled cloth material 21A shown in FIG. 4. And, the glued film layer 22 is an airproofed glue film. The glued film is pasted to the backside of the cloth material and an integrated material cloth 20 is thus formed.

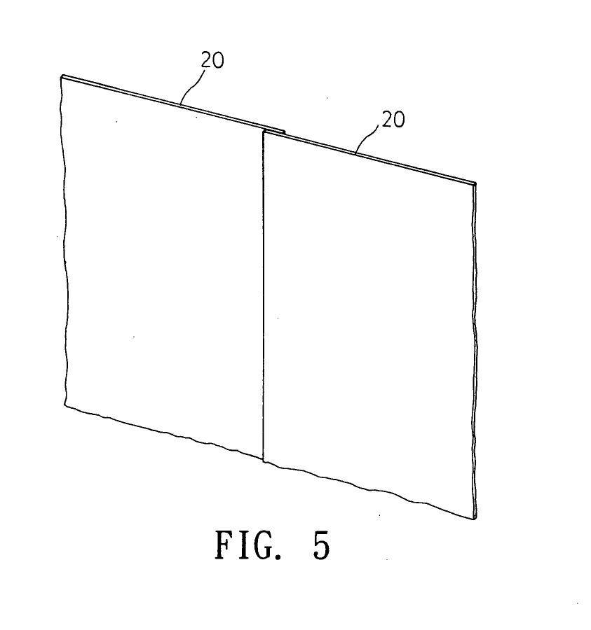

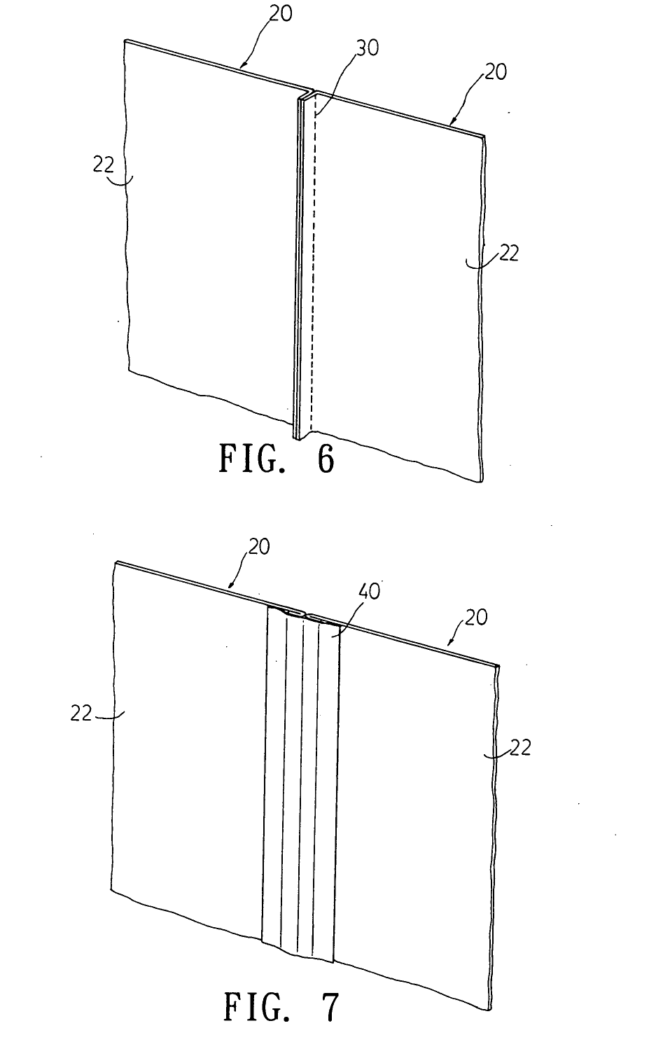

Please refer to those shown in FIG. 5 again. The integrated material cloth 20 composed of the cloth layer 21 and glued film layer 22 can be cut into the material cloth 20 with all kinds of shapes and dimensions. While making the modeled objects, the joint method between the material cloths can utilize the ultrasonic jig to achieve it as those shown in FIG. 5. Or as shown in FIGS. 6 and 7, it can utilize the sewing method to sew them from the back side (i.e., the glued film layer 22) of the material cloth 20 by the silk thread 30, and an airproofed tape 40 with high viscidity is then over-taped at the sewing position of the silk thread 30 such that to form a closely fit airproofed status at the sewing position of the silk thread. The material cloth 20 thus composed can make different kinds of punching modeled objects 10 with different cloth material sense and no specified external shape directly according to the requirements, and the manufacturing cost of this kind of punching modeled objects 10 can be greatly saved with this.

1-2. (canceled)

3. In a punching modeled objects made of a cloth structure, the improvement wherein said cloth structure comprises a first layer selected from lint cloth material or vertical pile cloth material; and a second layer made of an air-proofed glued film pasted to a backside of said first layer.
